(19) United States
(12) Patent Application Publication
(10) Pub. No.: US 2012/0261082 A1
(43) Pub. Date: Oct. 18, 2012

(54) WINDOW TREATMENT

(75) Inventor: Denise Marie Stoughton, New York, NY (US)

(73) Assignee: Croscill Home LLC

(21) Appl. No.: 13/086,030

(22) Filed: Apr. 13, 2011

(51) Int. Cl. A47H 5/02; E06B 9/24

(52) U.S. Cl. 160/184; 160/340

(57) ABSTRACT

Window treatments are provided that include a built-in mechanism for opening and closing the window treatment that is easy to use and does not detract from or enhances the aesthetic appearance of the window treatment. The window treatment includes a panel of fabric that has one or two drawstrings extending through a pocket of the panel. A user may pull on the drawstrings, typically from behind the panel (i.e., the window side), to contract the width of the panel, thereby “opening” the window treatment. The drawstrings may then be tied together or otherwise fastened to secure the panel in the open position. The drawstrings may be accessible from the window side of the panel and, thus, may not be visible to a viewer from the room side of the panel. In addition, because the drawstrings are part of the window treatment, no additional hardware or accessories are required.

### BACKGROUND

The present invention generally relates to window treatments and more specifically to panels of fabric having built-in drawstrings for the opening and closure of the window treatments.

In general, a window treatment is a covering for a window. Common methods and elements of window treatment include window blinds, shutters, curtains, and draperies. Window treatments serve several purposes, such as lessening the amount of light entering through a window, providing privacy, and enhancing the appearance of a room. In this regard, window treatments may also include other elements that can “dress up” the window, but may not be as functional as, for example, draperies. Such elements may include, for example, sheers and valances. In general, a valance is one or more additional panels of fabrics that extend along the top of the window, such as in front of curtains. The valance may be intended to help block sight of the curtain rod and any hardware supporting the window treatment or to provide more accent to the window treatment.

Window treatments often include a mechanism for opening and closing the window treatment. For example, the panels of fabric that make up a curtain may be configured to hang from a curtain rod, and the panels may be manually gathered to either end of the window to open the window treatment. In this case, the panels may not remain in the open position on their own, but may gradually slide closed due to the weight or thickness of the fabric. It may thus be necessary to purchase and install hooks on the wall at either end of the window for tie backs that can be used to hold the gathered panels in the open position.

Therefore, it would be beneficial to have window treatments that can be maintained in the opened and closed positions in a way that is simple, effective, does not require additional hardware or accessories, and at the same time does not detract from the aesthetic appearance of the window treatment.

### BRIEF SUMMARY

Window treatments are provided that include a built-in mechanism for opening and closing the window treatment that is easy to use and does not detract from, and may enhance, the aesthetic appearance of the window treatment. The window treatment includes a panel of fabric that has one or two drawstrings extending through a pocket of the panel. A user may pull on the drawstring(s), from behind the panel (i.e., the window side) or in front of the panel (i.e., the room side), to contract the width of the panel, thereby “opening” the panel. The drawstrings may then be tied together or otherwise fastened to each other or to the panel directly to maintain the panel in the open position. The drawstrings may be accessible from the window side of the panel and, thus, may not be visible to a viewer from the room side of the panel.

Accordingly, a window treatment is provided that includes a panel of a fabric and a first drawstring. The panel defines a first end, a second end, a first edge, and a second edge, and the first end defines a pocket extending from the first edge to the second edge that is configured to receive a rod. The first drawstring extends at least partially through the pocket. The panel, when installed on the rod, is configured to move from a closed position to an open position upon an application of tensile force on the first drawstring, and the first drawstring is configured to secure the panel in the open position.

In some cases, the window treatment also includes a second drawstring, and the first drawstring is configured to engage the second drawstring to secure the panel in the open position. The first drawstring may be attached to the panel at or near the first edge, and the second drawstring may be attached to the panel at or near the second edge, such that the application of tensile force on the first drawstring draws the first edge towards the second edge and the application of tensile force on the second drawstring draws the second edge towards the first edge.

The pocket may define an opening between the first edge and the second edge of the panel, and at least one of the first and second drawstrings may be accessible via the opening. In some embodiments, the opening of the pocket may be defined generally midway between the first edge and the second edge of the panel, and the second drawstring may extend at least partially through the pocket.

In some cases, the first and second drawstrings may be configured to be tied to each other. In addition, the panel may be secured in a partially open position, as opposed to a fully opened position. The panel may define a window face and a room face, and the first drawstring may be accessible from the window face. In some cases, the panel may be a valance.

In some embodiments, the window treatment includes two panels. The second panel may define a first end, a second end, a first edge, and a second edge, and the first end of the second panel may define a pocket extending from the first edge of the second panel to the second edge of the second panel that is configured to receive the rod. A third drawstring may also be provided that extends from the first edge of the second panel at least partially through the pocket of the second panel. The second panel, when installed on the rod, may be configured to move from a closed position to an open position upon an application of tensile force on the third drawstring, and the third drawstring may be configured to secure the second panel in the open position. In addition, the window treatment may also include a fourth drawstring extending from the second edge of the second panel, and the third drawstring may be configured to engage the fourth drawstring to secure the second panel in the open position.

In other embodiments, a window treatment may be provided that includes a panel of a fabric, a first drawstring, and a second drawstring. The panel may define a first end, a second end, a first edge, and a second edge, and the first end may define a pocket extending from the first edge to the second edge that is configured to receive a rod. The first drawstring may define a fixed end and a free end, and the fixed end of the first drawstring may be attached to the panel. Likewise, the second drawstring may define a fixed end and a free end, and the fixed end of the second drawstring may be attached to the panel. The free end of at least one of the first and second drawstrings may extend at least partially through the pocket, and pulling on the free end of at least one of the first and second drawstrings, when the panel is installed on the rod, may serve to contract a width of the panel. The free ends of the first and second drawstrings may be configured to secure the panel at the contracted width.

The fixed end of the first drawstring may be attached to the panel at or near the first edge, and the fixed end of the second drawstring may be attached to the panel at or near the second edge. The pocket may define an opening between the first edge and the second edge of the panel, and each of the free end of the first drawstring and the free end of the second drawstring may, in some cases, extend at least partially through the pocket. The free ends of the first and second drawstrings may be accessible via the opening. In some cases, the opening of the pocket may be defined generally midway between the first edge and the second edge of the panel, and the opening may be a slit in some instances.

In some embodiments, the panel may define a window face and a room face, and the free ends of the first and second drawstrings may be accessible from the window face. In some cases, the panel may be a valance.

The window treatment may, in some cases, include a first panel and a second panel. The second panel may define a first end, a second end, a first edge, and a second edge, and the first end of the second panel may define a pocket extending from the first edge of the second panel to the second edge of the second panel that is configured to receive the rod. A third drawstring may be provided that defines a fixed end and a free end, and the fixed end of the third drawstring may be attached to the second panel. A fourth drawstring may also be provided, where the fourth drawstring defines a fixed end and a free end, and the fixed end of the fourth drawstring may be attached to the second panel. The free end of at least one of the third and fourth drawstrings may extend at least partially through the pocket of the second panel. The window treatment may be configured such that pulling on the free end of at least one of the third and fourth drawstrings, when the second panel is installed on the rod, serves to contract a width of the second panel, and the free ends of the third and fourth drawstrings may be configured to secure the second panel at the contracted width.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a window treatment with two panels of fabric in a closed position according to an exemplary embodiment;

FIG. 2 shows the room face of a window treatment with a single panel of fabric in a closed position according to another exemplary embodiment;

FIG. 3 shows the window face of the window treatment of FIG. 2;

FIG. 3A is a close-up view of the drawstrings of the window treatment of FIG. 3;

FIG. 4 shows the room face of the window treatment of FIG. 2 in an open position;

FIG. 5 shows the window face of the window treatment of FIG. 4;

FIG. 6A illustrates the opening of the window treatment of FIG. 2 from a closed position;

FIG. 6B illustrates the further opening of the window treatment of FIG. 6A;

FIG. 6C illustrates the window treatment of FIG. 6A in an open position;

FIG. 7 shows the window treatment of FIG. 1 in an open position;

FIG. 8 shows the window treatment of FIG. 1 in another open position; and

FIG. 9 illustrates a window treatment with two panels of fabric in a closed position according to another exemplary embodiment.

### DETAILED DESCRIPTION OF THE INVENTION

Embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments provide one or more window treatments that include a built-in mechanism for opening and closing the window treatment that is easy to use and does not detract from, and in some cases adds to, the aesthetic appearance of the window treatment. In general, the window treatment, which may be, for example, a curtain or a valance, includes a panel of fabric that is provided with two drawstrings that extend through a pocket of the panel. A user may pull on the drawstring(s) from behind the panel (i.e., from a window side of the panel) to contract the width of the panel, thereby “opening” the curtain to expose, for example, the window over which the window treatment is installed. In the case of one drawstring, the drawstring may be fastened to the panel to secure the panel in the open position. In the case of two drawstrings, the drawstrings may then be tied together or otherwise fastened to each other or to the panel to secure the panel in the open position. Depending on the extent to which the drawstrings are pulled, the window treatment may be opened to varying degrees and may, for example, be held only partially open, as desired. The drawstrings may be accessible from the window side of the panel and thus may not be visible (or may be less visible) to a viewer from the room side of the panel, depending on the type of fabric used for the panel. In addition, because the drawstrings are part of the window treatment, no additional hardware or accessories are required for maintaining the panel in the open position.

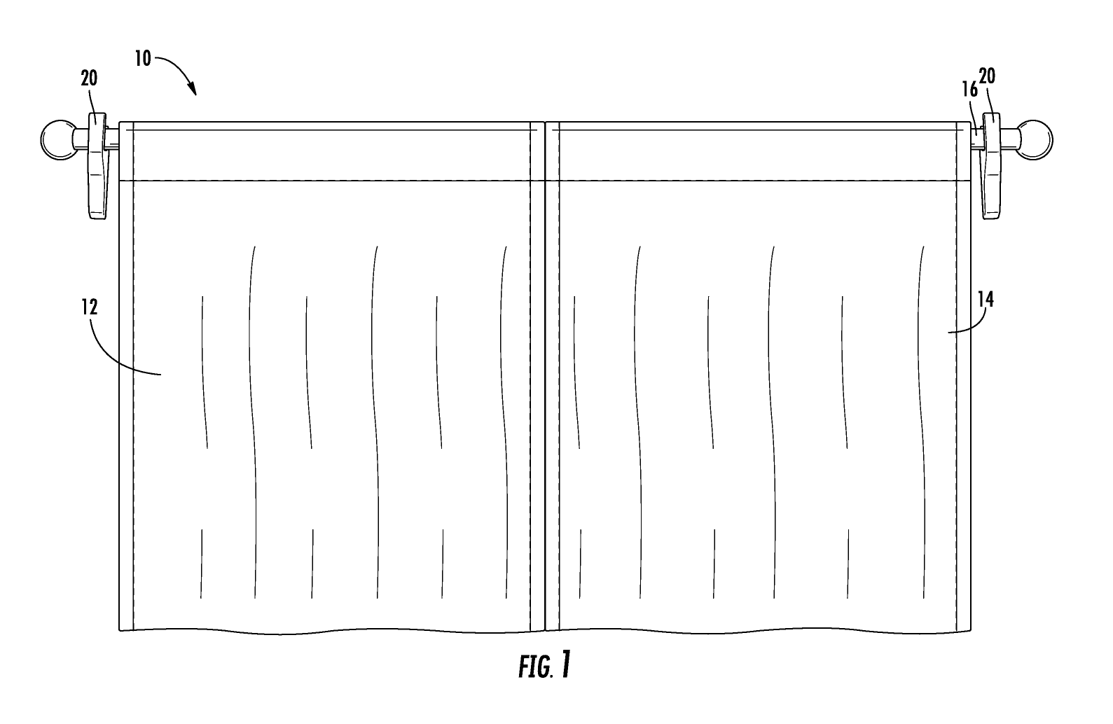

Turning now to FIG. 1, a window treatment 10 is depicted that includes two panels of fabric 12, 14 that are installed on a rod 16 so as to cover a window. It is noted that the window treatment need not cover a window, but may be used to cover a portion of wall, a picture, or any other item or fixture installed in or on the wall. The rod 16 may be mounted to the wall as known in the art, for example by using hooks 20 that are screwed into the wall at a desired location.

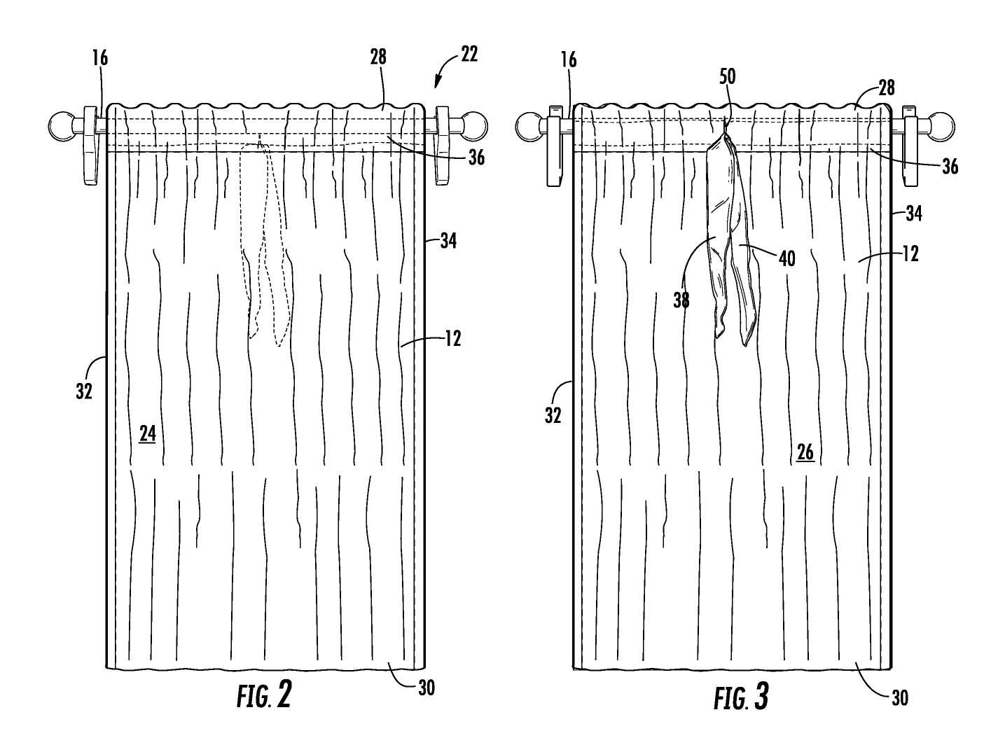

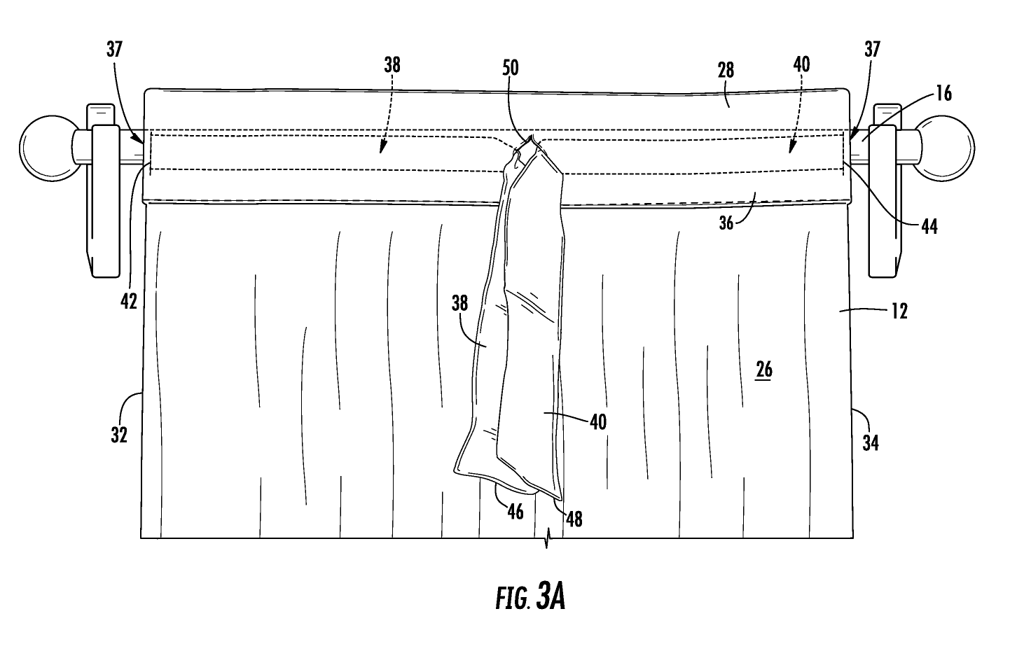

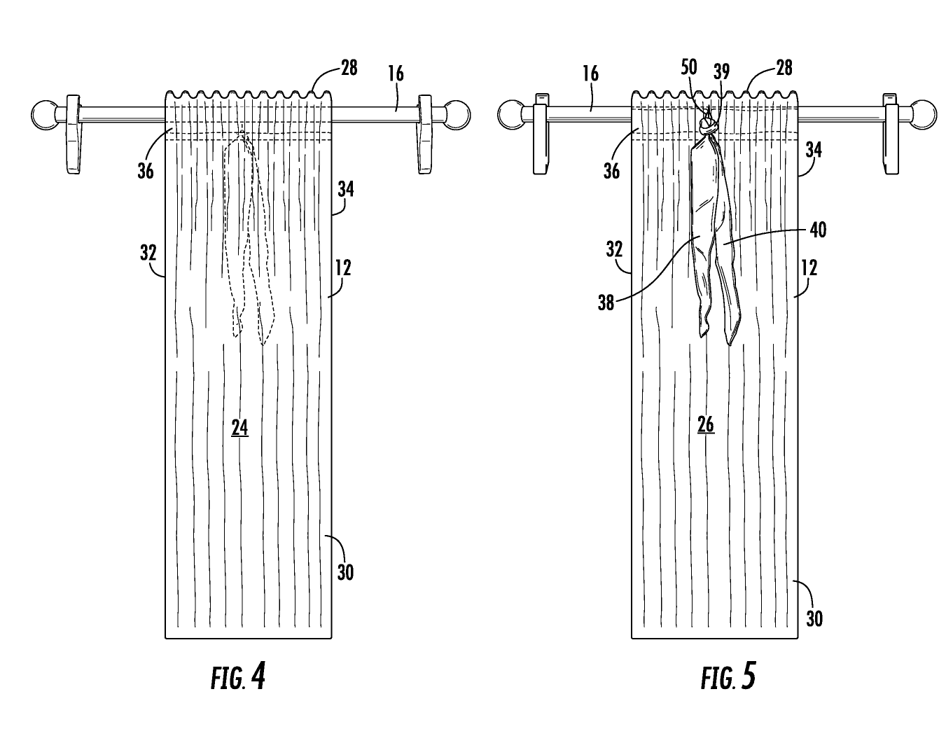

In some cases, a window treatment 22 may include a single panel of fabric 12, as shown in FIG. 2. Referring to the example of a window treatment 22 that has a single panel of fabric 12, as shown in FIGS. 2-5, the panel 12 may define a room face 24 (i.e., a surface of the panel that faces into the room and is thus seen by an occupant of the room), shown in FIGS. 2 and 4, and a window face 26 (i.e., a surface of the panel that faces away from the room, for example towards a window that the window treatment is covering), shown in FIGS. 3 and 5. The panel 12 may define a first end 28 and a second end 30, which, when the panel is installed on the rod, may, for example, be the top end and the bottom end of the panel, respectively. The panel 12 may further define a first edge 32 and a second edge 34, the first and second edges extending between the first end 28 and the second end 30 of the panel, as shown.

The first end 28 of the panel 12 may define a pocket 36 extending between the first edge 32 and the second edge 34. The pocket 36 may be formed, for example, by folding the first end 28 over onto itself and sewing the overlapping portions to create the pocket. The pocket 36 may thus be configured to receive the rod 16 therethrough to hang the panel 12 when the panel is in the installed position, as shown in the figures.

The window treatment 22 may further include a first drawstring 38 extending at least partially through the pocket 36 and, in some cases, may also include a second drawstring 40. Each drawstring 38, 40 may, for example, have a fixed end 42, 44 that is attached to the panel 12 and a free end 46, 48 that is not attached, as shown in FIG. 3A. In some embodiments, the fixed end 42 of the first drawstring 38 is attached to the panel 12 at or near the first edge 32, and the fixed end 44 of the second drawstring 40 is attached to the panel at or near the second edge 34. For example, the fixed ends 42, 44 may be sewn, adhered, or otherwise fastened to the panel. The free end 46, 48 of one or both drawstrings 38, 40 may extend at least partially through the pocket 36, such that when tensile force is applied on the first drawstring, the respective fixed end 42 “draws” the first edge 32 of the panel 12 along the rod 16, and/or when tensile force is applied on the second drawstring, the respective fixed end 44 “draws” the second edge 34 of the panel along the rod 16. In this way, the depicted panel, when installed on the rod, may be configured to move from a closed position (FIGS. 2 and 3) to an open position (FIGS. 4 and 5) upon the application of the tensile force on at least one of the first and second drawstrings 38, 40.

For example, in FIGS. 2-5, the fixed ends 42, 44 are attached to the panel 12 near the first and second edges 32, 34, respectively, and the free ends 46, 48 extend through the pocket 36 towards a midpoint of the pocket. In other embodiments, however, both fixed ends 42, 44 may be attached to the panel 12 at or near the same location, such as near the first edge 32, and the free end 46, 48 of only one of the drawstrings 38, 40 may extend at least partially through the pocket 36. For example, one of the drawstrings 38, 40 may extend the entire length of the pocket 36 and may wrap around to engage the other drawstring or the panel itself near the point of attachment with the panel, such as where the other drawstring hangs outside of the pocket.

In some embodiments, the pocket 36 defines an opening 50 between the first edge 32 and the second edge 34 of the panel 12, as shown in FIGS. 3, 3A, and 5. One or both of the drawstrings 38, 40 may be accessible to a user via the opening 50. For example, the opening 50 may be a slit (as depicted in the figures), a hole in the fabric, or a flap, among other types of openings in the pocket 36. As shown, in some cases both the first drawstring 38 and the second drawstring 40 may be accessible via the opening 50, with the respective free ends 46, 48 of one or both drawstrings extending at least partially through the pocket 36 and exiting the pocket via the opening.

In the depicted embodiments, the opening 50 is defined generally midway between the first edge 32 and the second edge 34 of the panel 12, as best seen in FIG. 3. In other embodiments, however, the opening may be closer to one or the other of the first and second edges 32, 34, or multiple openings may be provided, e.g., one opening for each drawstring 38, 40. In some cases, open ends 37 of the pocket 36 (shown in FIG. 3A) may serve as the openings to provide access to the respective drawstrings 38, 40, such as when the drawstrings are attached to the panel 12 near the center of the pocket and extend out towards the first and second edges 32, 34.

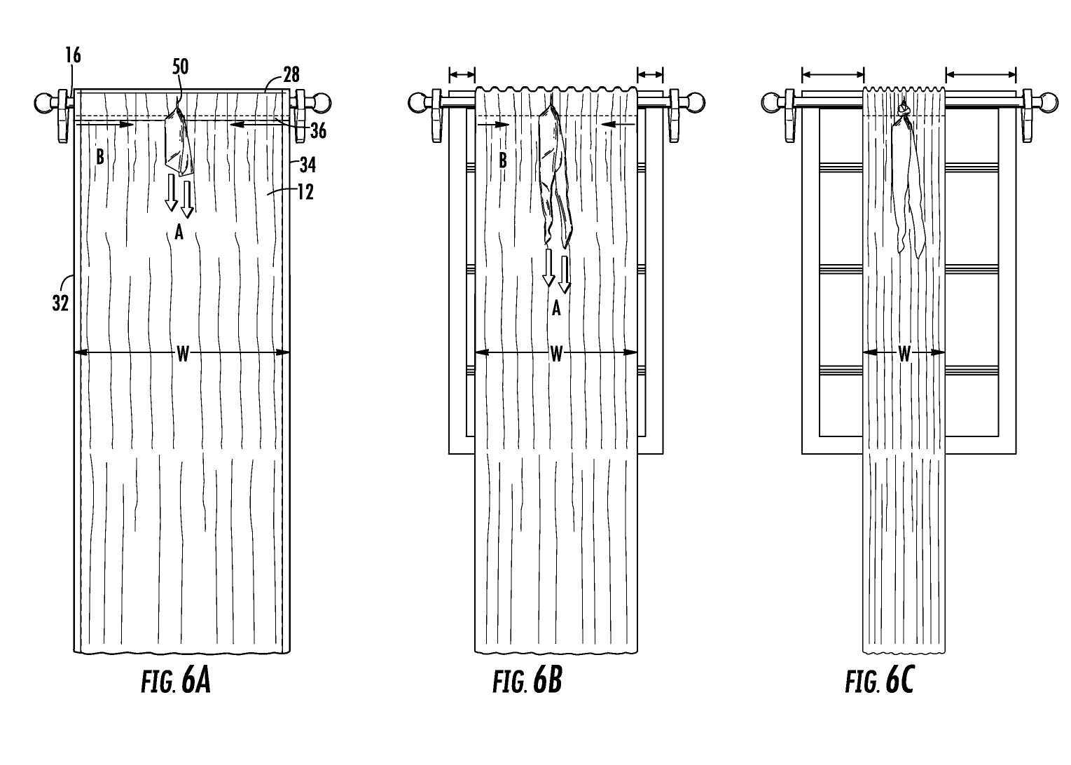

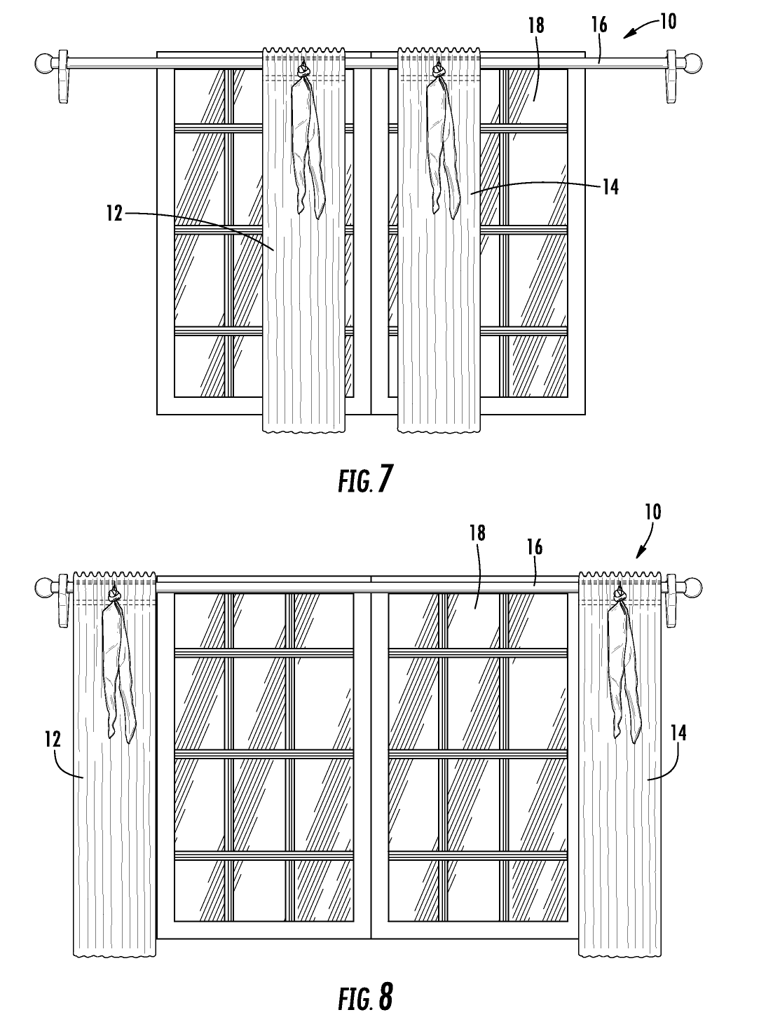

As illustrated in FIGS. 6A-6C, the application of tensile force on the first drawstring 38 can draw the first edge 32 towards the second edge 34, and the application of tensile force on the second drawstring 40 can draw the second edge towards the first edge. In other words, by pulling on the free end 46, 48 of one or both drawstrings 38, 40 (e.g., in the direction A) when the panel 12 is installed on the rod, a width W of the panel is contracted (e.g., in the direction B), thereby “opening” the window treatment.

The first and second drawstrings 38, 40 may be configured to engage one another, as shown in FIGS. 5 and 6C, to secure the panel 12 in an open position (e.g., to maintain the contracted width of the panel). In some cases, as shown in FIGS. 5 and 6C, the first and second drawstrings 38, 40 may be configured to be tied to each other, such as in a simple knot 39 or in a bow. In other cases, one or both of the first and second drawstrings 38, 40 may be configured to be fastened to each other or to the panel 12, for example by using a clip, snaps, a button and hole, a hook and loop fastener, a band, or a tie. In cases in which a single drawstring 38 is used, the drawstring may be configured to be fastened to the panel 12 directly to secure the panel in the open position.

The first and/or second drawstrings 38, 40 may in some cases by accessible from the window face 26 of the panel 12, rather than the room face 24, for example to avoid detracting from the aesthetic appeal of the window treatment by at least partially hiding the drawstrings behind the panel of fabric itself. For example, the opening 50 may be formed in the window face 26 of the panel 12, as illustrated in FIGS. 2-5, and the free ends 46, 48 of the respective drawstrings 38, 40 may be accessible from the window face via the opening. Alternatively, for example when decorative drawstrings are used, the opening 50 may be formed in the room face 24 of the panel 12, allowing the drawstrings to enhance the aesthetic appearance of the window treatment. Drawstrings that are accessible from the room face are illustrated in FIGS. 6A-8.

Turning again to FIGS. 6A-6C, in general, the panel 12 may be opened to varying degrees (e.g., may be partially opened, as opposed to fully opened) by controlling the extent to which the first and/or second drawstrings 38, 40 are pulled and secured. Thus, by pulling on the first and/or second drawstrings 38, 40 to only a small degree, as shown in FIG. 6B, the width W of the panel 12 may be contracted to a lesser degree than if the drawstrings are pulled with greater force or for a longer duration, as shown in FIG. 6C. Securing the first and/or second drawstrings 38, 40, such as by tying the drawstrings together, may thus keep the window treatment at any desired open position, providing flexibility to the user as to how open the window treatment should be.

As noted above, rather than a single panel 12, the window treatment 10 may include first and second panels 12, 14, as shown in FIGS. 1, 7, and 8. In this regard, each of the panels 12, 14 may be configured as described above. Thus, the panels may be configured to move from a closed position to an open position upon the application of tensile force on one or both of the drawstrings of the respective first and second panels 12, 14.

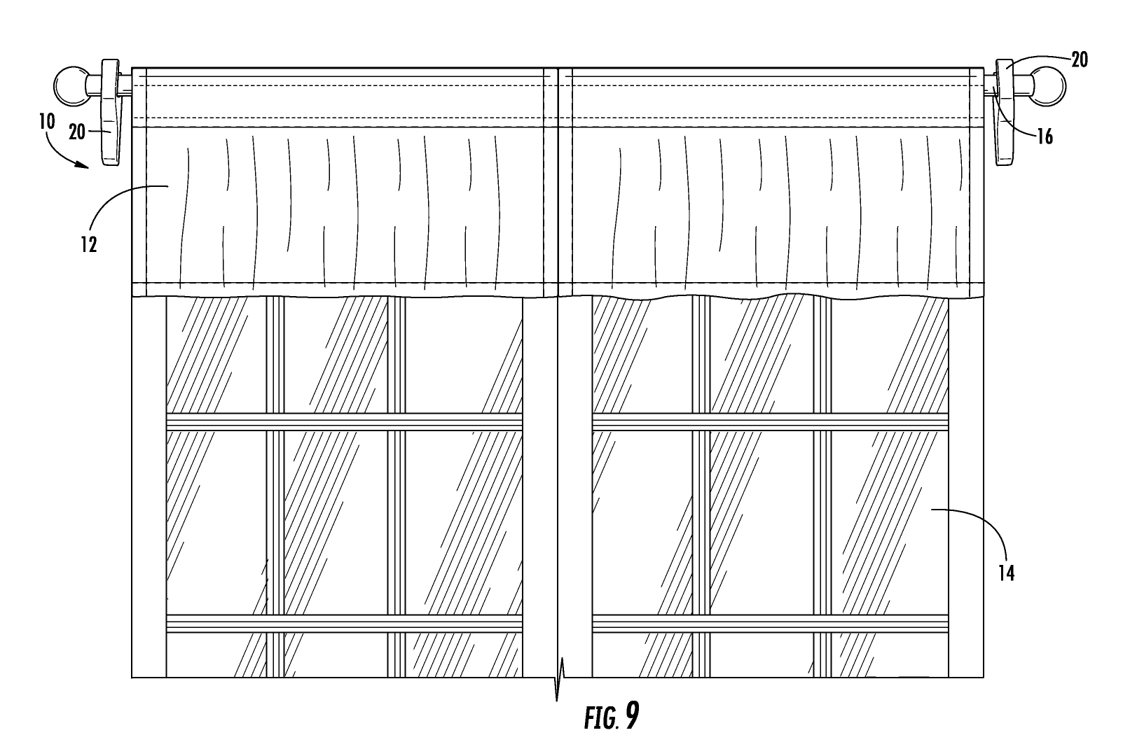

As illustrated in FIGS. 7 and 8, for example, pulling on the free end of the drawstrings of the first panel 12 and the second panel 14 when the panels are installed, as shown, contracts the width of the respective panels, and the free ends of the drawstrings of each panel may then be engaged with one another (e.g., a user may tie together the drawstrings of each respective panel) or affixed to the panel itself (e.g., in the case of a single drawstring on each panel) to secure the panels at the contracted width. The contracted panels 12, 14 may then be positioned at any location along the rod 16, as desired by the user. For example, as shown in FIG. 7, each contracted panel 12, 14 may be generally centered with respect to the window 18 that it covers. As another example, each contracted panel 12, 14 may be moved towards a respective end of the rod 16, thereby exposing a greater central portion of the window 18, as shown in FIG. 8.

The window treatment 10 may further have more than two panels, such as, for example, four panels of fabric. Furthermore, the panels 12, 14 of the window treatment 10, 22 may be configured to be drapes or curtains in some cases (FIGS. 1-8) and valances in other cases (FIG. 9).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A window treatment comprising:
a panel of a fabric defining a first end, a second end, a first edge, and a second edge, wherein the first end defines a pocket extending from the first edge to the second edge that is configured to receive a rod; and
a first drawstring extending at least partially through the pocket,
wherein the panel, when installed on the rod, is configured to move from a closed position to an open position upon an application of tensile force on the first drawstring, and
wherein the first drawstring is configured to secure the panel in the open position.

2. The window treatment of claim 1 further comprising a second drawstring, wherein the first drawstring is configured to engage the second drawstring to secure the panel in the open position.

3. The window treatment of claim 2, wherein the first drawstring is attached to the panel proximate the first edge and the second drawstring is attached to the panel proximate the second edge such that the application of tensile force on the first drawstring draws the first edge towards the second edge and the application of tensile force on the second drawstring draws the second edge towards the first edge.

4. The window treatment of claim 2, wherein the pocket defines an opening between the first edge and the second edge of the panel, and wherein at least one of the first and second drawstrings is accessible via the opening.

5. The window treatment of claim 4, wherein the opening of the pocket is defined generally midway between the first edge and the second edge of the panel.

6. The window treatment of claim 2, wherein the second drawstring extends at least partially through the pocket.

7. The window treatment of claim 2, wherein the first and second drawstrings are configured to be tied to each other.

8. The window treatment of claim 1, wherein the open position comprises a partially open position.

9. The window treatment of claim 1, wherein the panel defines a window face and a room face, and wherein the first drawstring is accessible from the window face.

10. The window treatment of claim 1, wherein the panel is a valance.

11. The window treatment of claim 1, wherein the panel is a first panel, the window treatment further comprising:
a second panel of a fabric defining a first end, a second end, a first edge, and a second edge, wherein the first end of the second panel defines a pocket extending from the first edge of the second panel to the second edge of the second panel that is configured to receive the rod; and
a third drawstring extending from the first edge of the second panel at least partially through the pocket of the second panel;
wherein the second panel, when installed on the rod, is configured to move from a closed position to an open position upon an application of tensile force on the third drawstring, and
wherein the third drawstring is configured to secure the second panel in the open position.

12. The window treatment of claim 11 further comprising a fourth drawstring extending from the second edge of the second panel, wherein the third drawstring is configured to engage the fourth drawstring to secure the second panel in the open position.

13. A window treatment comprising:
a panel of a fabric defining a first end, a second end, a first edge, and a second edge, wherein the first end defines a pocket extending from the first edge to the second edge that is configured to receive a rod;
a first drawstring defining a fixed end and a free end, wherein the fixed end of the first drawstring is attached to the panel; and
a second drawstring defining a fixed end and a free end, wherein the fixed end of the second drawstring is attached to the panel,
wherein the free end of at least one of the first and second drawstrings extends at least partially through the pocket, and
wherein pulling on the free end of at least one of the first and second drawstrings, when the panel is installed on the rod, serves to contract a width of the panel, and wherein the free ends of the first and second drawstrings are configured to secure the panel at the contracted width.

14. The window treatment of claim 13, wherein the fixed end of the first drawstring is attached to the panel proximate the first edge and the fixed end of the second drawstring is attached to the panel proximate the second edge.

15. The window treatment of claim 14, wherein the pocket defines an opening between the first edge and the second edge of the panel, wherein each of the free end of the first drawstring and the free end of the second drawstring extends at least partially through the pocket, and wherein the free ends of the first and second drawstrings are accessible via the opening.

16. The window treatment of claim 15, wherein the opening of the pocket is defined generally midway between the first edge and the second edge of the panel.

17. The window treatment of claim 15, wherein the opening is a slit.

18. The window treatment of claim 13, wherein the panel defines a window face and a room face, and wherein the free ends of the first and second drawstrings are accessible from the window face.

19. The window treatment of claim 13, wherein the panel is a valance.

20. The window treatment of claim 13, wherein the panel is a first panel, the window treatment further comprising:
a second panel of a fabric defining a first end, a second end, a first edge, and a second edge, wherein the first end of the second panel defines a pocket extending from the first edge of the second panel to the second edge of the second panel that is configured to receive the rod;
a third drawstring defining a fixed end and a free end, wherein the fixed end of the third drawstring is attached to the second panel; and
a fourth drawstring defining a fixed end and a free end, wherein the fixed end of the fourth drawstring is attached to the second panel,
wherein the free end of at least one of the third and fourth drawstrings extends at least partially through the pocket of the second panel, and
wherein pulling on the free end of at least one of the third and fourth drawstrings, when the second panel is installed on the rod, serves to contract a width of the second panel, and wherein the free ends of the third and fourth drawstrings are configured to secure the second panel at the contracted width.
